(19) United States
(12) Patent Application Publication
(10) Pub. No.: US 2023/0052994 A1
(43) Pub. Date: Feb. 16, 2023

(54) SMART SPEAKER, MULTI-VOICE ASSISTANT CONTROL METHOD, AND SMART HOME SYSTEM

(71) Applicant: THIRD REALITY, INC., Zhenjiang, Jiangsu (CN)

(72) Inventor: Xuezhang DONG, Zhenjiang, Jiangsu (CN)

(21) Appl. No.: 17/758,065

(22) PCT Filed: Dec. 31, 2019
(86) PCT No.: PCT/CN2019/130464

§ 371 Date: Jun. 27, 2022

(51) Int. Cl. G10L 17/22; G10L 17/14; G10L 17/04; H04R 3/00; G06F 3/16; G10L 17/02; H04L 12/28

(52) U.S. Cl. CPC G10L 17/22; G10L 17/14; G10L 17/04; H04R 3/00; G06F 3/165; G10L 17/02; H04L 12/282; H04R 2420/07; H04R 2430/01; H04L 2012/2841

(57) ABSTRACT

The invention discloses a smart loudspeaker, wherein the smart loudspeaker includes a voice input module, a language recognition module and at least two voice assistants, and the language recognition module receives a voice information from the voice input module and determines the language category based on the voice information and activates the voice assistant corresponding to the language category.

### TECHNICAL FIELD

The invention relates to the field of artificial intelligence, in particular to a smart loudspeaker, a multi-voice-assistants control method and a smart home system.

### TECHNICAL BACKGROUND

With the vigorous development of Internet of Things technology, smart homes gradually come into the public's field of vision. Among them, smart loudspeakers are popular due to their advantages in human-computer interaction, voice control, entertainment games, and information broadcasting. Driven by the third wave of the world's information industry, many companies have participated in the big market of smart loudspeakers and developed a variety of smart loudspeakers to enrich people's smart lives.

At present, most brands of smart loudspeakers still have limitations, and more humanized needs from the details are not considered. There are the following problems:

First of all, it only supports single language or multi-language switching, but it needs to be set up in advance and can only wake up the smart loudspeaker in the current language. When there are people in different languages at home, good user experience cannot be achieved.

Secondly, the physical control keys of smart loudspeakers are generally volume down key, volume up key, mute key, wake-up key, etc, without one key that can control smart home devices. When the user cannot use the APP or voice to control the smart home devices, one cannot choose other control methods and loses the ability to manage the device.

### SUMMARY

The object of the present invention is to provide a smart loudspeaker, a multi-voice-assistants control method and a smart home system to solve the above problems in the prior art.

In order to solve the above problems, according to an aspect of the present invention, a smart loudspeaker is provided, wherein the smart loudspeaker includes a voice input module, a language recognition module and at least two voice assistants, the language recognition module receives voice information from the voice input module, determines a language category based on the voice information, and activates the voice assistant corresponding to the language category.

In one embodiment, the language recognition module is configured to collect the pronunciations of the same wake-up word from multiple countries, then classify these audios according to different countries, and train a language-distinguishing classifier to realize language recognition.

In one embodiment, the voice assistant includes a voiceprint recognition module for performing a voiceprint authentication on a user when the user uses a specific function.

In one embodiment, the smart loudspeaker is provided with a one-key control key, which is associated with one or more smart home devices to one-key control the home devices associated with the one-key control key.

In one embodiment, the smart loudspeaker further includes a wireless communication module, a mobile communication module and a control module, the wireless communication module and the mobile communication module are signally connected to and interact with the control module.

In one embodiment, the smart loudspeaker further includes a speaker, a volume up control key and a volume down control key, the volume up control key and the volume down control key are connected to the speaker to control the volume of the speaker, and the volume up control key and the volume down control key are also respectively associated with the wireless communication module and the mobile communication module and control on-off of the wireless communication module and the mobile communication module.

In one embodiment, the smart loudspeaker further includes a circuit board, the wireless communication module, the mobile communication module and the control module are integrated on the circuit board.

In one embodiment, the smart loudspeaker includes a base, the mobile communication module is disposed on the base, and the smart loudspeaker is connected with the mobile communication module by configuring WIFI.

In one embodiment, the voiceprint recognition module performs the following steps:

inputting a voice information through the voiceprint recognition module;

scoring according to the voice information through the voiceprint recognition module;

through the voiceprint recognition module, comparing an obtained score with a threshold; if the obtained score is higher than the threshold, authorizing a user to operate; if the obtained score is lower than the threshold, prohibiting the current user from operating.

In one embodiment, the voice assistants include an English voice assistant, a French voice assistant and a Chinese voice assistant.

According to another aspect of the present invention, a multi-voice-assistants controll method is provided, which is applied to an electronic device integrating a plurality of voice assistants, a voice input module and a language recognition module, the method includes the following steps:

step 1, inputting voice through the voice input module;

step 2: through the language recognition module, receiving a voice information from the voice input module, determining a language category based on the voice information, and activating the voice assistant corresponding to the language category according to the language category.

In one embodiment, the voice assistant includes a voiceprint recognition module, and the step 2 includes the following steps:

inputting an external instruction through the voice assistant;

through the voice assistant, determining whether the external instruction contains a keyword of a specific function, and if yes, activating the voiceprint recognition module, otherwise executing an instruction function.

In one embodiment, the voiceprint recognition module performs the following steps:

inputting a voice information through the voiceprint recognition module;

scoring according to the voice information through the voiceprint recognition module;

through the voiceprint recognition module, comparing an obtained score with a threshold, and if the obtained score is higher than the threshold, authorizing a user to operate, and if the obtained score is lower than the threshold, prohibiting the current user from performing the current operation.

According to another aspect of the present invention, a smart home system is provided, which includes the above-mentioned smart loudspeaker, a smart home server, and at least one smart home device, the smart loudspeaker is in communication with the smart home server, the smart home server is in communication with the at least one smart home device, so that the smart home device can be controlled through the smart loudspeaker.

In one embodiment, the smart home device includes a smart switch, a smart light and/or a smart curtain.

The present invention has the following beneficial effects:

First, users can interact with a smart loudspeaker in multiple languages, and select any two languages through an APP to use the loudspeaker at the same time, including using different languages to wake up the loudspeaker, talking with the loudspeaker, and control smart home devices through the loudspeaker;

Second, through the one-key control key on the loudspeaker, one can control smart home devices with one key.

### DESCRIPTION OF DRAWINGS

FIG. 1 is a front view of a smart loudspeaker according to an embodiment of the present invention.

FIG. 2 is a top view of the smart loudspeaker of FIG. 1.

FIG. 3 is a cross-sectional view of the smart loudspeaker of FIG. 2 taken along line A-A.

FIG. 4 is a control block diagram of a wireless communication module according to an embodiment of the present invention.

FIG. 5 is a control block diagram of a mobile communication module according to an embodiment of the present invention.

FIG. 6 is a schematic block diagram of a control system of a smart loudspeaker according to an embodiment of the present invention.

FIG. 7 is an operational block diagram of the control system of FIG. 6.

FIG. 8 is a operational block diagram of a voice assistant including a voiceprint recognition module.

FIG. 9 is an operational block diagram of a voiceprint recognition module according to an embodiment of the present invention.

### EMBODIMENTS

Embodiments

The preferred embodiment of this invention will be described in detail with reference to the accompanying drawings, so that the purposes, the characteristics and the advantages of the invention can be more clearly understood. It should be understood that the embodiments shown in the figures are not intended to limit the scope of this invention, but illustrate the essential spirit of the technical solution of this invention.

In the following description, certain specific details are set forth for purposes of illustrating the various disclosed embodiments to provide a thorough understanding of the various disclosed embodiments. However, those skilled in the art will recognize that embodiments may be practiced without one or more of these specific details. In other instances, well-known devices, structures, and techniques associated with the present application may not be shown or described in detail to avoid unnecessarily obscuring the description of the embodiments.

Throughout the specification “one embodiment” or “an embodiment” means that a particular feature, structure, or characteristic described in connection with the embodiment is included in at least one embodiment. Therefore, the presence of “in one embodiment” or “in an embodiment” at various locations throughout the specification need not all refer to the same embodiment. Additionally, particular features, structures, or features may be combined in any manner in one or more embodiments.

In the following description, for clarity of illustration of the structure and mode of operation of the present invention, various directional terms will be used to describe the present invention, but words such as “front”, “rear”, “left”, “right”, “outer”, “inner”, “outward”, “inward”, “upper”, “lower”, and the like, should be understood as convenient terms and should not be construed as limiting terms.

The main innovations included in the present invention:

First, users can interact with a smart loudspeaker in multiple languages, and select any two languages through an APP to use the loudspeaker at the same time, including using different languages to wake up the loudspeaker, talking with the loudspeaker, and control smart home devices through the loudspeaker;

Second, through the one-key control key on the loudspeaker, you can control smart home devices with one key.

In order to achieve the above object, according to an aspect of the present invention, a technical solution of multi-language interactive use is adopted, that is, a plurality of natural language processing (NLP) modules are simultaneously run on the smart loudspeaker. Depending on the wake word, choose to enable different NLP modules. For example, when the user speaks a wake-up word “Hello Shushi”, the Chinese NLP module is activated, and the subsequent interaction between the user and the smart loudspeaker is processed by the Chinese NLP module. The user's speech data is successively processed by the module's cloud-end automatic speech recognition technology (ASR) and natural language understanding technology (NLU), as well as providing smart home IoT services. If the user uses a wake-up word in another language, such as “Alexa”, a processing module of the other language is activated, and then the speech data is processed by the corresponding processing module.

In order to achieve the above object, according to another aspect of the present invention, a smart loudspeaker is provided, which includes a voice input module, a language recognition module and at least two voice assistants, the language recognition module receives a voice information from the voice input module, determines a language category based on the voice information and activates the voice assistant corresponding to the language category.

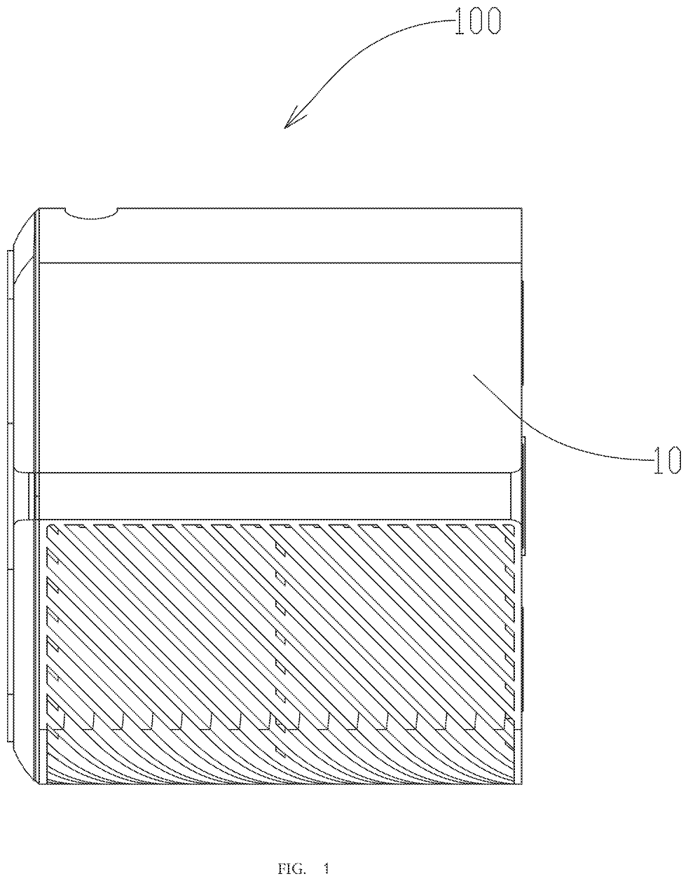

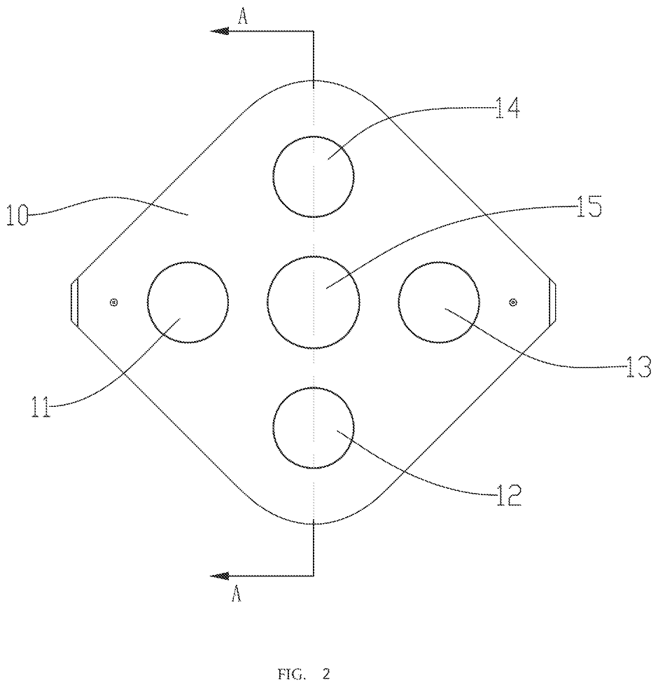

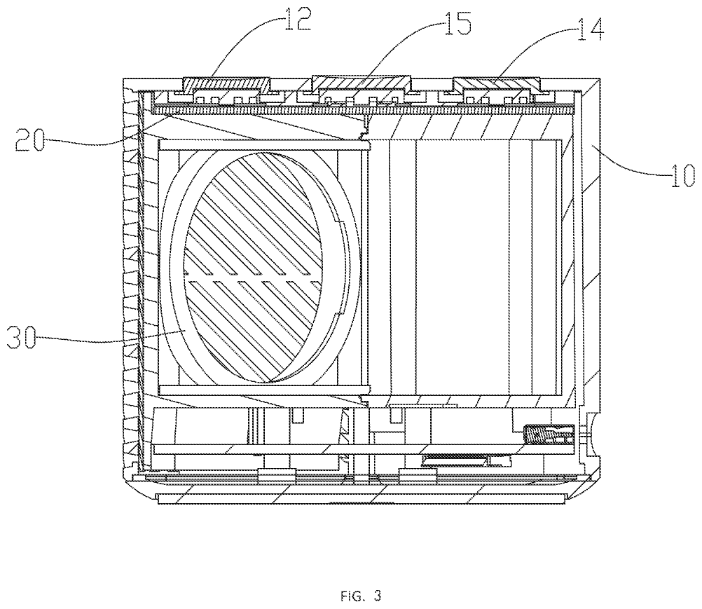

Specific embodiments of the present invention will be described below with reference to the accompanying drawings. FIG. 1 is a front view of the smart loudspeaker 100, FIG. 2 is a top view of the smart loudspeaker 100 of FIG. 1, and FIG. 3 is a cross-sectional view taken along line A-A of FIG. 2. As shown in FIGS. 1-3, the smart loudspeaker 100 generally includes a speaker housing 10, which is provided with a circuit board 20 and a speaker 30. The housing 10 is further provided with a one-key control key 15 on the middle of the upper surface thereof, and a microphone key 11, a volume down control key 12, an activation key 13 and a volume up control key 14 are provided around the one-key control key 15. Although the function keys in this embodiment are arranged in this way, those skilled in the art should understand that the positions of the function keys can also be adjusted, replaced or rearranged at other positions on the housing.

The microphone key 11 is used to control on-off of the microphone, the volume control keys 12 and 14 are used to control the volume of the speaker 30, and the one-key control key 15 is associated with various smart home devices, such as smart switches, smart curtains, etc, so that these smart home devices can be one-key turned on or turned off by the one-key control key 15.

The circuit board 20 is provided with a wireless communication module, a control module (CPU), and a mobile communication module. The wireless communication module and the mobile communication module are signally connected to and interact with the control module, and associated with the volume control keys 12 and 14 (for example, the volume up control key or the volume down control key), so that the wireless communication module and the mobile communication module can be controlled to be turned on and off through the volume control keys 12 and 14 respectively.

In another embodiment of the present invention, the mobile communication module may not be integrated on the circuit board, but be directly arranged in a base provided at the bottom of the smart loudspeaker, the mobile communication module can be used as a WIFI hot spot, at this time, the base is a portable WIFI. By setting the account password of the portable WIFI on the mobile APP, the smart loudspeaker can be connected with the matching portable WIFI by configuring account of WIFI transmitter.

Those skilled in the art can understand that the above-mentioned mobile communication module can be implemented by a 3G module, a 4G module, and/or a 5G module.

A control method of the mobile communication module and the wireless communication module integrated on the circuit board is as follows. Those skilled in the art can understand that the mobile communication module and the wireless communication module may also have other control methods, and this control method is only an example.

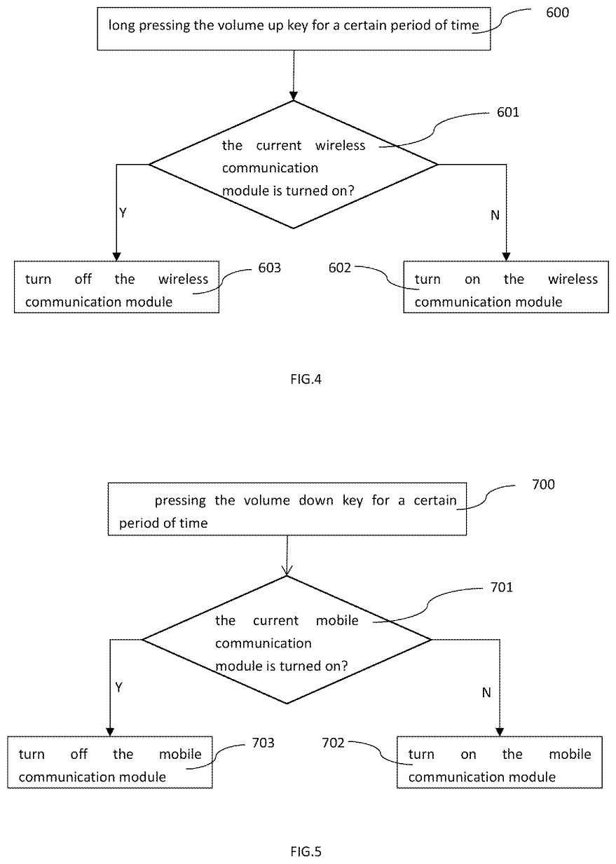

FIG. 4 is a control block diagram of the wireless communication module of the present invention. As shown in FIG. 4:

In step 600, pressing the volume up key for a certain period of time to start operation;

Then go to step 601: determining whether the current wireless communication module is turned on; if the current wireless communication module is not turned on, then go to step 602 to turn on the wireless communication module; if the current wireless communication module is turned on, then go to step 603 to turn off the wireless communication module.

FIG. 5 is a control block diagram of the mobile communication module of the present invention. As shown in FIG. 5:

In step 700, pressing the volume down key for a certain period of time to start operation;

Then go to step 701: determining whether the current mobile communication module is turned on; if the current mobile communication module is turned on, then go to step 703 to turn off the mobile communication module; if the current mobile communication module is not turned on, then go to step 702 to turn on the mobile communication module.

The smart loudspeaker of the present invention can be freely switched between a wireless communication signal and a mobile communication signal. If the wireless communication signal and the mobile communication signal are turned on at the same time, the wireless communication, such as WIFI, is used first by default. If there is no wireless communication signal, for example the WIFI network is unavailable, the mobile communication signal, such as a 4G network, is used. Specifically, if the loudspeaker only has a wireless communication network, such as a WIFI network, the smart loudspeaker is networked through the wireless communication network, such as WIFI; if the loudspeaker only has a mobile communication network, such as a 4G network, the smart loudspeaker is networked through the mobile communication network, such as 4G; if the loudspeaker has both a mobile communication network and a wireless communication network, such as 4G and WIFI networks, the smart loudspeaker uses the wireless communication network first, such as WIFI network.

It should be noted that the wireless communication module of the present invention can be implemented by means of a WIFI module, and the mobile communication module can be implemented by, for example, a 5G module, a 4G module, or a 3G module.

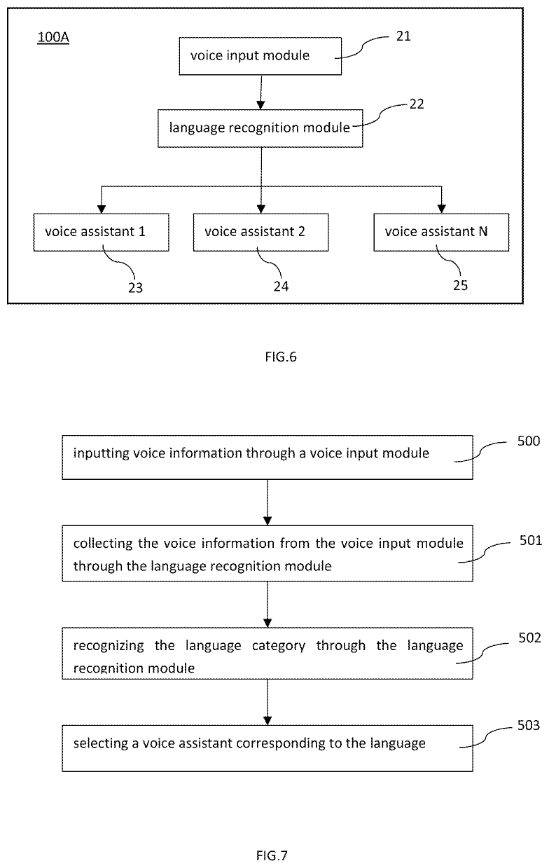

FIG. 6 is a schematic block diagram of a control system 100A of a smart loudspeaker according to an embodiment of the present invention. The control system 100A of the smart loudspeaker of the present invention will be described with reference to FIG. 6 as follows. As shown in FIG. 6, the control system 100A includes a voice input module 21, a language recognition module 22, and a plurality of voice assistants, such as voice assistant 23, voice assistant 24, and voice assistant 25. The voice input module 21 is used for receiving voice input, and the language recognition module 22 receives the voice information from the voice input module 21 and determines a language category based on the voice information, and then selects the voice assistant corresponding to the language category according to the determined language category.

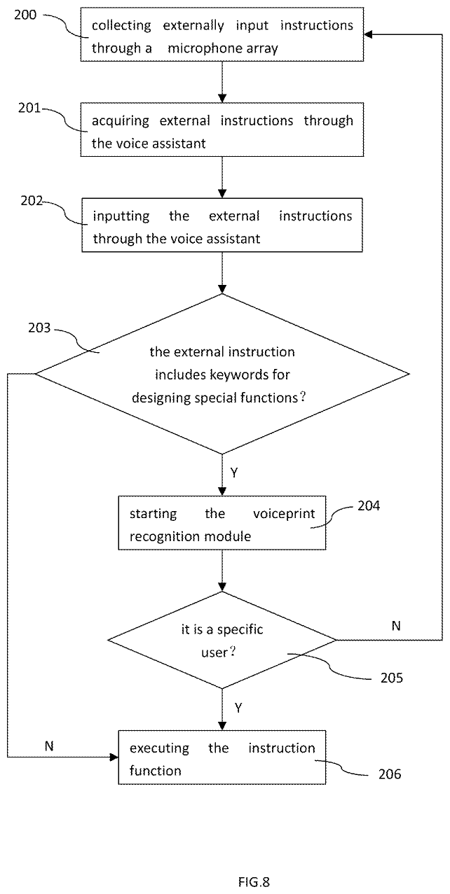

FIG. 7 shows an operational block diagram of the control system 100A. As shown in FIG. 7:

In step 500: inputting voice information through a voice input module (such as a microphone);

then go to step 501: collecting the voice information from the voice input module through the language recognition module;

then go to step 502: recognizing the language category through the language recognition module;

then go to step 503: selecting a voice assistant corresponding to the language according to the language category recognized in step 502.

For example, when the user inputs the word “Alexa” through the voice input module 21, due to the pronunciation habits of different languages, the pronunciation of “Alexa” in French and “Alexa” in German have different pronunciation habits, the language recognition module 22 receives the voice information from the voice input module 21, determines the language category, for example, in French or German, and selects the corresponding French voice assistant or German voice assistant. This is essentially different from ordinary smart loudspeakers that can only switch to different voice assistants through different wake-up words. It can use the same wake-up word to wake up smart loudspeakers and automatically switch to the voice assistant of the corresponding language, which is convenient for people in different languages. For example, in a multilingual home, people in different languages can communicate with the smart loudspeaker, and further use the voice information to control other smart devices at home through the smart loudspeaker 100, such as smart switches, smart curtains, etc., which will be further discussed below.

The implementation method of the language recognition module 22 is described below. First, collecting the pronunciations of the same wake-up word from each country; then classifying these audios according to different countries; training a language-distinguishing classifier to obtain a language recognition model; and the language recognition module 22 can use the language recognition model to implement language recognition.

A scenario corresponding to this embodiment is as follows:

Integrating and applying an AISPEECH Voice Assistant and an Amazon Voice Assistant into the smart loudspeaker 100, and setting the wake-up words of both the AISPEECH Voice Assistant and the Amazon Voice Assistant to be “Alexa”.

The Chinese-speaking user first sends “Alexa” to the electronic device, and the AISPEECH Voice Assistant is awakened (the Amazon voice assistant keeps monitoring), and then the user continues to send the instruction “Shanghai weather today”, and the AISPEECH Voice Assistant uploads the instruction to a cloud server through the network, the cloud server processes the instruction and sends the result (which can be a voice packet) back to the AISPEECH Voice Assistant, and the AISPEECH Voice Assistant responds to user with the processing result (sends “The weather is cloudy in Shanghai today, 25°”).

After that, the English-speaking user sends “Alexa” to the electronic device, then Amazon voice assistant is awakened (AISPEECH voice assistant interrupts the previous audio/response process), then the user continues to send the instruction “What's the weather of Shanghai today”, and the Amazon voice assistant uploads the instruction to the cloud server through the network, the cloud server processes the instruction and sends the result (which can be a voice packet) back to the Amazon voice assistant, and the Amazon voice assistant responds to the user with the processing result (sends “Today the weather of Shanghai is cloudy”).

Using the above method, when there are members in different languages in a family, members in different languages can wake up the loudspeaker through the same wake-up word, and choose the habitual language to talk to the loudspeaker according to their own language habits.

According to another embodiment of the present invention, each voice assistant further includes a voiceprint recognition module to define specific functions (such as payment functions) to be used only by specific users. FIG. 8 shows the flow chart diagram of the voice assistant including the voiceprint recognition module. As shown in FIG. 8:

In step 200, collecting externally input instructions through a microphone array.

Then go to step 201: acquiring external instructions through the voice assistant.

Then go to step 202: inputting the external instructions through the voice assistant.

Then go to step 203: determining whether the external instruction includes keywords for designing special functions (such as payment, purchase, etc.) through the voice assistant, if yes, go to step 204: starting the voiceprint recognition module, otherwise go to step 206: executing the instruction function.

After executing step 204, go to step 205: determining whether it is a specific user? If yes, go to step 206: executing the instruction function, otherwise return to step 200: collecting externally input instructions through a microphone array.

In this embodiment, the microphone array can take various forms: linear, annular and spherical, for example: 2 microphone arrays, 6+1 microphone arrays and 8+1 microphone arrays, with long pickup distance, good noise suppression, and better collection effect.

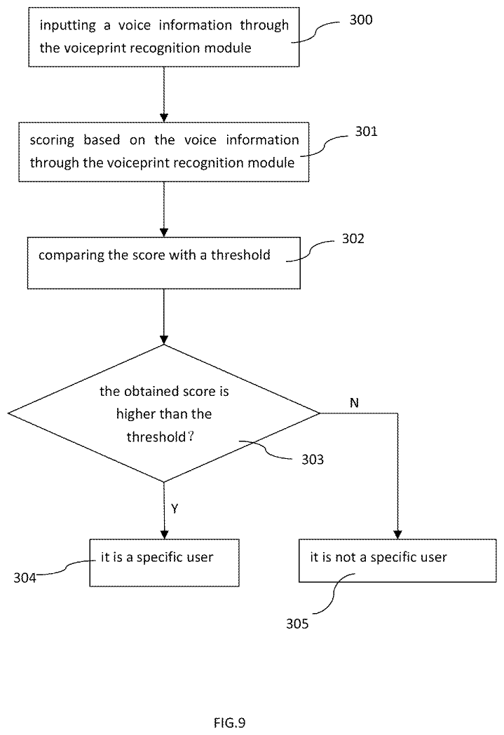

The implementation method of step 205 will be described below with reference to FIG. 9. Step 205 includes the steps shown in FIG. 9, which is a block diagram of the operation of the voiceprint recognition module. As shown in FIG. 9:

In step 300, inputting a voice information through the voiceprint recognition module.

Then go to step 301: scoring based on the voice information through the voiceprint recognition module.

Then go to step 302: comparing the score obtained in step 301 with a threshold through the voiceprint recognition module.

Then go to step 303: determining the comparison result in step 302, if the obtained score is higher than the threshold, go to step 304, if the obtained score is lower than the threshold, go to step 305.

According to another embodiment of the present invention, it also relates to a smart home system, which includes the above-mentioned smart loudspeaker, a smart home server and at least one smart home device, the smart loudspeaker is in communication with the smart home server, and the smart home server is in communication with at least one smart home device, so that smart home device can be controlled through the smart loudspeaker. The smart home device may include a smart switch, a smart light, a smart curtain, and the like.

In one embodiment, the smart device can be cross-controlled in two languages. For example, in the family members, member A is a native English speaker, while member B is a native Chinese speaker, and member A talks to the smart loudspeaker in English and sends instructions in English to turn on the smart home device (such as turning on the smart switch), and then member B can talk with the smart loudspeaker in Chinese and sends instructions in Chinese to turn off the smart home device (such as turn off the smart switch), so that cross-control of the smart device in two languages can be realized. It can be seen that the smart home system of the present invention is very suitable for multilingual family members, the same wake-up word can wake up the smart loudspeaker, and realize the cross-control of smart devices in two or more languages.

In one embodiment, the smart loudspeaker is provided with a one-key control key, which is associated with one or more smart home devices, so that the one-key control key can control the smart home device associated with the one-key control key.

Each method implementation of the present invention may be implemented in software, hardware, firmware, and the like. Regardless of whether the invention is implemented in software, hardware, or firmware, the instruction code may be stored in any type of computer-accessible memory (e.g., permanent or modifiable, volatile or non-volatile, solid-state solid or non-solid, fixed or replaceable media, etc.).Likewise, the memory may be, for example, Programmable Array Logic (“PAL” for short), Random Access Memory (“RAM” for short), Programmable Read

Only Memory (“PROM” for short), Read-Only Memory (“ROM” for short), Electrically Erasable Programmable Read-Only Memory (“EEPROM” for short), magnetic disk, optical disk, Digital Versatile Disc (, “DVD” for short) and so on.

It should be noted that each module mentioned in each device embodiment of the present invention is a logical module. Physically, a logical module may be a physical module, or a part of a physical module, or a combination of a plurality of physical modules. The physical implementation of these logic modules is not the most important, and the combination of functions implemented by these logic modules is the key to solving the technical problem proposed by the present invention. In addition, in order to highlight the innovative part of the present invention, the above-mentioned device embodiments of the present invention do not introduce modules that are not closely related to solving the technical problems proposed by the present invention, which does not mean that the above-mentioned device embodiments do not have other modules.

It should be noted that, in the specification of this patent, relational terms such as first and second, etc. are only used to distinguish one entity or operation from another entity or operation, and do not necessarily require or imply these entities or that there is any such actual relationship or sequence between entities or operations. Moreover, the terms “including”, “comprising” or any other variation thereof are intended to encompass non-exclusive inclusion such that a process, method, article or device comprising a list of elements includes not only those elements, but also includes not explicitly listed or other elements inherent to such a process, method, article or apparatus. Without further limitation, an element qualified by the phrase “comprising a/an” does not preclude the presence of additional identical elements in a process, method, article or device that includes the element.

The preferred embodiments of the present invention have been described in detail, but it should be understood that, after reading the above teachings of the present invention, various modifications or modification of the present invention can be made by those skilled in the art. These equivalent forms are also within the scope defined by the claims appended hereto.

1. A smart loudspeaker, wherein the smart loudspeaker comprises a voice input module, a language recognition module and at least two voice assistants, the language recognition module receives a voice information from the voice input module and recognize a language category based on the voice information and activates the voice assistant corresponding to the language category.

2. The smart loudspeaker according to claim 1, wherein the language recognition module is configured to collect pronunciations of a same wake-up word from multiple countries, then classify these audios according to different countries, and train a language-distinguishing classifier to realize language recognition.

3. The smart loudspeaker according to claim 1, wherein the voice assistant comprises a voiceprint recognition module for performing a voiceprint authentication on a user when the user uses a specific function.

4. The smart loudspeaker according to claim 1, wherein the smart loudspeaker is provided with a one-key control key, which is associated with one or more smart home devices to one-key control the home devices associated with the one-key control key.

5. The smart loudspeaker according to claim 4, wherein the smart loudspeaker further comprises a wireless communication module, a mobile communication module and a control module, and the wireless communication module and the mobile communication module are signally connected to and interact with the control module.

6. The smart loudspeaker according to claim 5, wherein the smart loudspeaker further comprises a speaker, a volume up control key and a volume down control key, the volume up control key and the volume down control key are connected to the speaker to control a volume of the speaker, and the volume up control key and the volume down control key are also associated with the wireless communication module and the mobile communication module respectively and control on-off of the wireless communication module and the mobile communication module.

7. The smart loudspeaker according to claim 5, wherein the smart loudspeaker further comprises a circuit board, the wireless communication module, the mobile communication module and the control module are integrated on the circuit board.

8. The smart loudspeaker according to claim 5, wherein the speaker comprises a base, the mobile communication module is arranged on the base, and the smart loudspeaker is connected with the mobile communication module by configuring an account of wireless transmitter.

9. The smart loudspeaker according to claim 3, wherein the voiceprint recognition module performs the following steps:
inputting a voice information through the voiceprint recognition module;
scoring the voice information through the voiceprint recognition module;
through the voiceprint recognition module, comparing an obtained score with a threshold, if the obtained score is higher than the threshold, authorizing a user to operate, if the obtained score is lower than the threshold, prohibiting the current user from operating.

10. The smart loudspeaker according to claim 1, wherein the voice assistants comprise an English voice assistant, a French voice assistant and a Chinese voice assistant.

11. A method for controlling multi-voice-assistants, wherein the method is applied to an electronic device integrating a plurality of voice assistants, a voice input module and a language recognition module, and the method includes the following steps:
step 1, inputting voice through the voice input module;
step 2: through the language recognition module, receiving a voice information from the voice input module, determining the language category based on the voice information, and activating the voice assistant corresponding to the language category according to the language category.

12. The method according to claim 11, wherein the voice assistant comprises a voiceprint recognition module, and the step 2 further comprising the following steps:
inputting an external instruction through the voice assistant;
through the voice assistant, determining whether the external instruction contains a keyword of a specific function, and if yes, activating the voiceprint recognition module, otherwise executing the specific function.

13. The method according to claim 12, wherein the voiceprint recognition module performs the following steps:
inputting a voice information through the voiceprint recognition module;
scoring based on the voice information through the voiceprint recognition module;
through the voiceprint recognition module, comparing an obtained score with a threshold, and if the obtained score is higher than the threshold, authorizing the user to operate, and if the obtained score is lower than the threshold, prohibiting the current user from performing the current operation.

14. A smart home system, wherein the smart home system comprises the smart loudspeaker according to claim 1, a smart home server and at least one smart home device, the smart loudspeaker is in communication with the smart home server, and the smart home server is in communication with the at least one smart home device, so that the smart home device is able to be controlled through the smart loudspeaker.

15. The smart home system according to claim 14, wherein the smart home device comprises a smart switch, a smart light and/or a smart curtain.
